(19) United States
(12) Patent Application Publication
(10) Pub. No.: US 2026/0208381 A1
(43) Pub. Date: Jul. 23, 2026

(54) replaceable visual craft punch

(71) Applicant: Ninghai County Lize Stationery Co., Ltd., Ningbo City (CN)

(72) Inventor: Jianguo Zhang, Ningbo City (CN)

(21) Appl. No.: 19/445,988

(22) Filed: Jan. 12, 2026

(30) Foreign Application Priority Data
Jan. 22, 2025 (CN) 2025201489466

(51) Int. Cl. B26D 7/26; B26D 5/10; B26D 7/00

(52) U.S. Cl. CPC B26D 7/2614; B26D 5/10; B26D 2007/0018

(57) ABSTRACT

A replaceable visual craft punch includes a craft punch body, and the craft punch body includes a main housing, a punching assembly, and a visual component, where a through slot is formed on the main housing, and provides a passage for entry and exit of a cutting tool component. The visual component includes a protective cover mounted on the main housing, a single-sided opening is formed on a side of the protective cover adjacent to the main housing to facilitate flat placement of materials of different widths, and a front face of the protective cover is provided with a discharge outlet. The present disclosure breaks the strict limitation of a traditional craft punch on a material width, ensures that a user observes the punching process in real time and clearly, and accurately controls a position and final presentation effect of pattern, thereby reducing the error rate.

### CROSS-REFERENCE TO RELATED APPLICATIONS

This is a U. S. patent application which claims the priority and benefit of Chinese Patent Application Number 2025201489466, filed on January 22, 2025, the disclosure of which is incorporated herein by reference in its entirety.

### TECHNICAL FIELD

The present disclosure relates to the technical field of hand tools, and in particular to a replaceable visual craft punch.

### BACKGROUND

A craft punch is a hand tool used to make decorative patterns on papers, fabrics, and other materials. The craft punch creates exquisite patterns on various materials such as paper and cloth through a specific blade structure, which adds decorative effects for crafting. Most of craft punches currently available on the market employ a vertical insertion method for operation, which imposes relatively strict requirements on material widths. Moreover, since a punching area is obscured by a housing during the operation, the user cannot intuitively observe the punching process, and fails to accurately control positions and effects of patterns, thereby causing inconvenience in crafting.

Therefore, in view of this, research and improvements have been made to the structures and defects in the prior art, and a replaceable visual craft punch is provided to achieve the objective of higher practical value.

### SUMMARY

In order to overcome the above defects in the prior art, the present disclosure provides a replaceable visual craft punch to solve the problems in the background above.

The present disclosure adopts the following technical solution: A replaceable visual craft punch includes a craft punch body, where the craft punch body includes a main housing, a punching assembly, and a visual component, and a through slot is formed on a front face of the main housing, and is configured to provide a passage for entry and exit of a cutting tool component; the visual component includes a protective cover, the protective cover is mounted on the front face of the main housing, a single-sided opening is formed on a side of the protective cover adjacent to the main housing to facilitate flat placement of materials of different widths to be processed, and a front face of the protective cover is provided with a discharge outlet to facilitate taking out a cut-off material; a visual cover plate is installed in the discharge outlet through a rotating column, and the visual cover plate is made of a transparent material, such that a user observes a punching process in real time and clearly through the visual cover plate, and controls a position and effect of pattern; and the punching assembly includes a cutting tool component and a driving mechanism, where the driving mechanism drives the cutting tool component to operate, so as to achieve a punching operation.

Further, the cutting tool component includes a blade installation cover, a blade base, and a limiting base, where the blade installation cover is detachably installed in the main housing, and an end opening thereof corresponds to the through slot on the main housing, the blade base is disposed in the blade installation cover and ejected by the driving mechanism, and cooperates with the limiting base mounted on an inner side of the protective cover to complete a punching action, the blade base is provided with a blade edge, and the limiting base is provided with a blade hole, where the blade edge and the blade hole are closely fitted to ensure the accuracy and quality of punching.

Further, the driving mechanism includes a cylindrical sleeve, an ejector column, a rotating rod, a pushing member, a connector, and a handle, where the cylindrical sleeve is integrally formed with the blade installation cover, which plays a stable guiding role for the ejector column, and the ejector column slides smoothly in the cylindrical sleeve, to push the blade base to achieve a punching operation; the rotating rod is connected in the main housing through a bearing, and an end thereof extends out of the main housing and is connected to the handle; the pushing member is fixed on an outer surface of the rotating rod, the connector is fixed on the pushing member, the connector is connected to the ejector column in a hinged manner, and when the user presses down the handle, the ejector column is driven to push through the pushing member and the connector in cooperation with the cylindrical sleeve, such that a convenient and efficient operation is achieved.

Further, four guide columns are installed in the blade installation cover blade base is provided with four guide grooves corresponding to the guide columns, which provides precise guidance for the blade base and the blade edge during operation, prevents deviation, and further ensures the punching accuracy.

Further, a rubber seat is fixedly mounted at an end of the ejector column close to the blade base, and the rubber seat not only has an anti-slip function and prevents slipping when the ejector column comes into contact with the blade base, but also has a buffering function, reduces an impact force, and prolongs the service life of the replaceable visual craft punch.

Further, the handle includes an S-shaped connecting rod and a sphere, where the S-shaped connecting rod is connected to a distal end of the rotating rod, the sphere is fixed at an end of the S-shaped connecting rod away from the rotating rod, and an outer surface of the sphere is wrapped with a rubber sleeve, which conforms to ergonomic design principles, facilitates the user’s holding, and enhances use comfort.

Further, a return spring is mounted on a back side of the pushing member, an end of the return spring is fixedly connected to an inner wall of the main housing, and after one punching operation, the return spring automatically drives the rotating rod to reset, without need of manual adjustment, which enables to quickly start the next punching operation and improves the work efficiency.

Further, a bottom end of the main housing has an opening, and a bottom sealing plate is detachably installed in the opening, which greatly facilitates maintenance, repair, and replacement of internal components of the main housing; and anti-slip protruding strips are uniformly fixed at a bottom end of the bottom sealing plate, which enhances stability of the craft punch body when placed, and prevents accidental sliding during operation.

Further, a trigger portion is disposed on a front face of the visual cover plate, and the user conveniently opens the visual cover plate by pressing the trigger portion to clean the discharge outlet or inspect an internal condition; and a magnet is mounted on an inner side of the visual cover plate, and magnetic adsorption enhances sealing stability of the visual cover plate when closed, and prevents leakage of debris.

Further, the handle further includes a connecting sleeve, an insertion portion, and a connecting end, where the connecting sleeve is connected to the S-shaped connecting rod, the connecting end is disposed at the distal end of the rotating rod, the insertion portion is disposed on the connecting sleeve, and the insertion portion is adapted to the connecting end, which achieves quick disassembly and assembly of the handle, meets different carrying needs, and improves portability of the replaceable visual craft punch.

Further, the craft punch body further includes a quick assembly mechanism configured to quickly replace different punching assemblies, the quick assembly mechanism includes a connecting opening portion disposed on the main housing, and two engaging grooves are formed at an edge of the connecting opening portion; two elastic engaging portions adapted to the engaging grooves are disposed at a bottom end of the punching assembly, and quick installation of the punching assembly is achieved by aligning the elastic engaging portions with the engaging grooves; and a press-fit fastener is further disposed on the elastic engaging portion, and locking between the punching assembly and the main housing is quickly released by pressing the press-fit fastener upward.

The present disclosure has the following beneficial effects and advantages:

1. The present disclosure breaks the strict limitation of a traditional craft punch on a material width by arranging the protective cover and the single-sided opening formed on the side adjacent to the main housing. A visual cover plate is made of a transparent material, and this design ensures that a user observes the punching process in real time and clearly, and accurately controls a position and final presentation effect of pattern, thereby reducing the error rate.

2. The present disclosure achieves higher punching accuracy and quality by arranging the cutting tool components with special structures, namely the blade installation cover, the blade base, and the limiting base. The blade edge on the blade base is closely fitted with the blade hole of the limiting base, which ensures that each punching operation is accurately completed, and patterns are clear and regular, thereby meeting requirements of fine crafting; and the design of arranging the driving mechanism including the cylindrical sleeve and the ejector column makes the punching operation more convenient and efficient. When the user presses down the handle, the ejector column is driven to accurately push the blade base through the pushing member and the connector in cooperation with the cylindrical sleeve, and the punching operation is completed in a smooth, easy, and labor-saving manner; the design of arranging four guide columns in the blade installation cover and corresponding guide grooves on the blade base achieves precise guidance for the operation of the blade base and the blade edge, effectively prevents deviation, further ensures the punching accuracy, and reduces the rejection rate; the design of fixedly installing the rubber seat at an end of the ejector column close to the blade base not only achieves an anti-slip function and prevents slipping when the ejector column comes into contact with the blade base, but also achieves a buffering function, reduces an impact force, prolongs the service life of the replaceable visual craft punch, and reduces maintenance costs; the design of arranging the unique handle including the S-shaped connecting rod, the sphere, and related connecting components, conforms to ergonomic design principles, facilitates the user’s holding, enhances the use comfort, prevents fatigue after long-term use, and makes crafting more pleasant; the design of mounting the return spring on the back side of the pushing member ensures that after one punching operation, the return spring automatically drives the rotating rod to reset, without need of manual adjustment, which enables to quickly start the next punching operation, greatly improves the work efficiency, and speeds up the crafting process; the design of arranging the opening at the bottom end of the main housing and detachably mounting the bottom sealing plate greatly facilitates maintenance, repair, and replacement of internal components of the main housing, makes the later maintenance easy and convenient, and saves time and effort; the design of uniformly fixing the anti-slip protruding strips at the bottom end of the bottom sealing plate, enhances stability of the craft punch body when placed, prevents accidental sliding during operation, ensures the operational safety, and prevents punching errors or device damage caused by sliding; the design of arranging the trigger portion on the front face of the visual cover plate and the magnet on the inner side thereof ensures that the user conveniently opens the visual cover plate to clean the discharge outlet or inspect the internal condition, so as to keep the replaceable visual craft punch clean; and additionally, magnetic adsorption enhances sealing stability of the visual cover plate when closed, prevents leakage of debris, maintains a clean operation environment, and facilitates fine crafting.

3. Through the arrangement of the quick assembly mechanism of the present disclosure, when the punching assembly needs to be disassembled, the user only needs to pull the press-fit fastener upward, and the press-fit fastener drives the elastic engaging portion to deform and detach from the engaging groove, such that locking between the punching assembly and the main housing is quickly released, thereby achieving the quick disassembly of the punching assembly.

### BRIEF DESCRIPTION OF THE DRAWINGS

FIG. 1 is a first structural perspective view of the present disclosure.

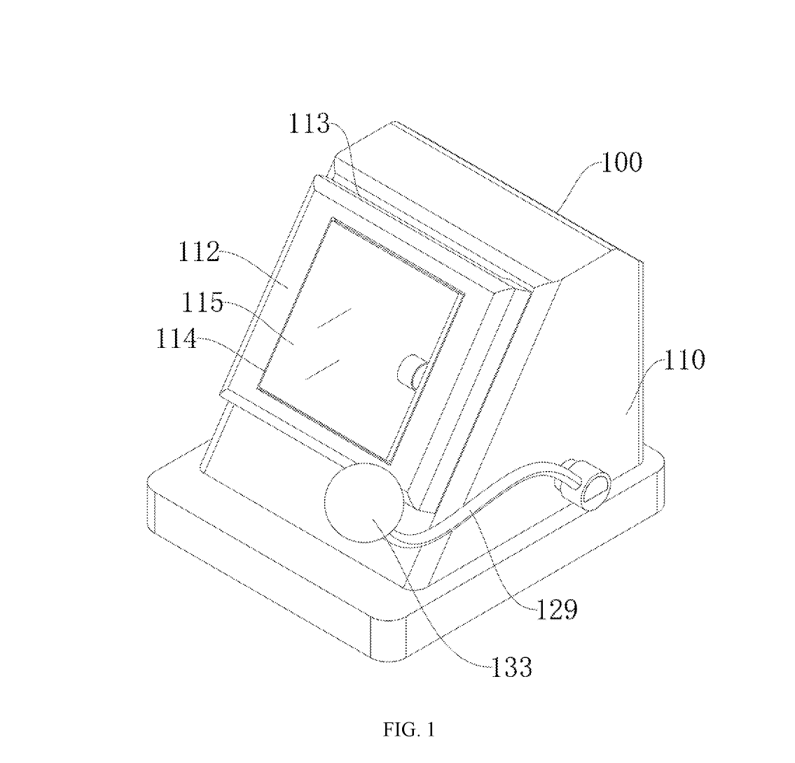

FIG. 2 is a second structural perspective view of the present disclosure.

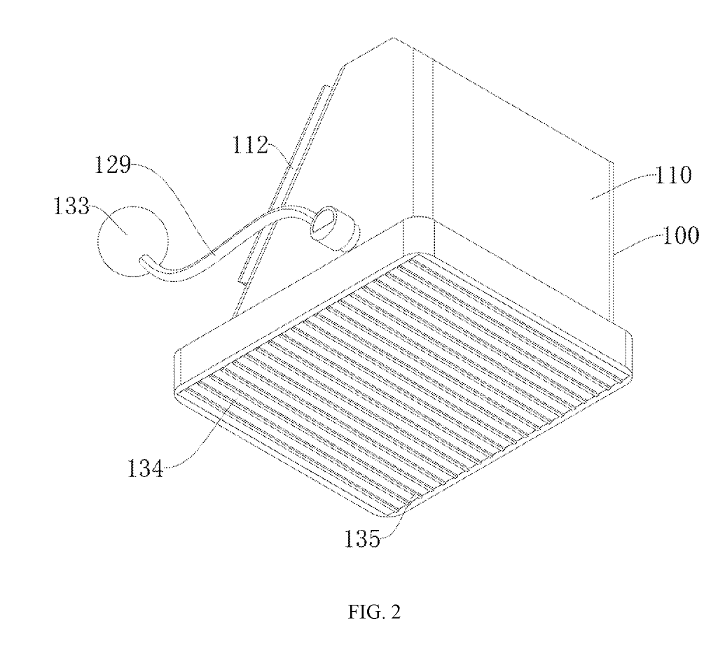

FIG. 3 is a third structural perspective view of the present disclosure.

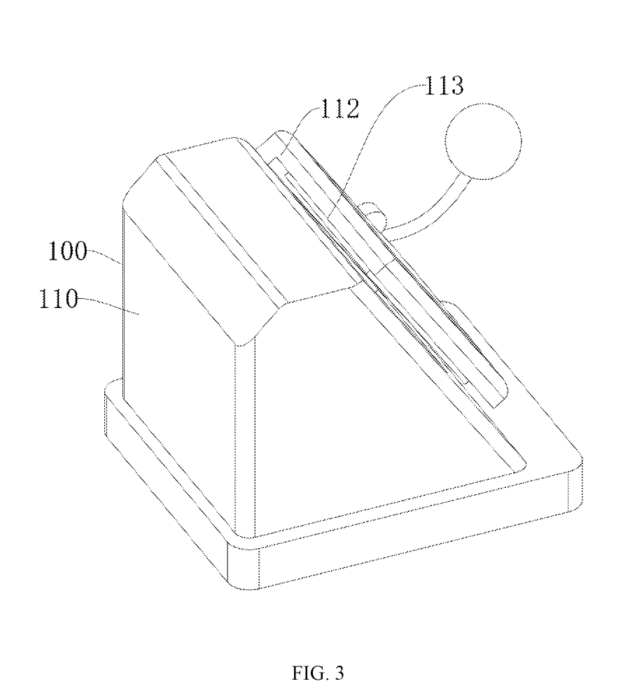

FIG. 4 is a first structural exploded perspective view of the present disclosure.

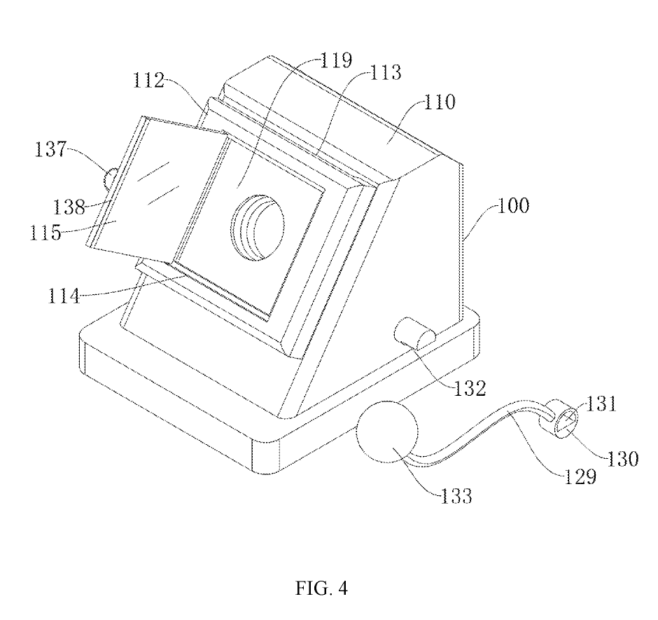

FIG. 5 is a second structural exploded perspective view of the present disclosure.

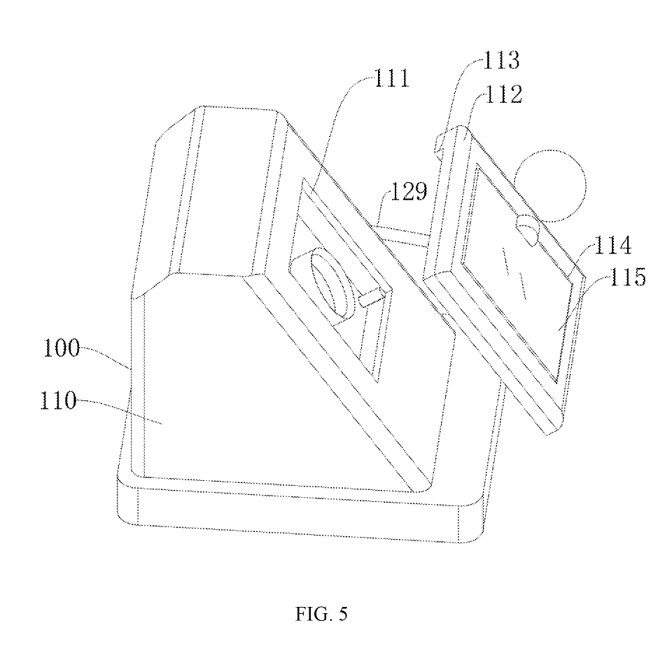

FIG. 6 is a structural perspective view of an interior of a main housing of the present disclosure.

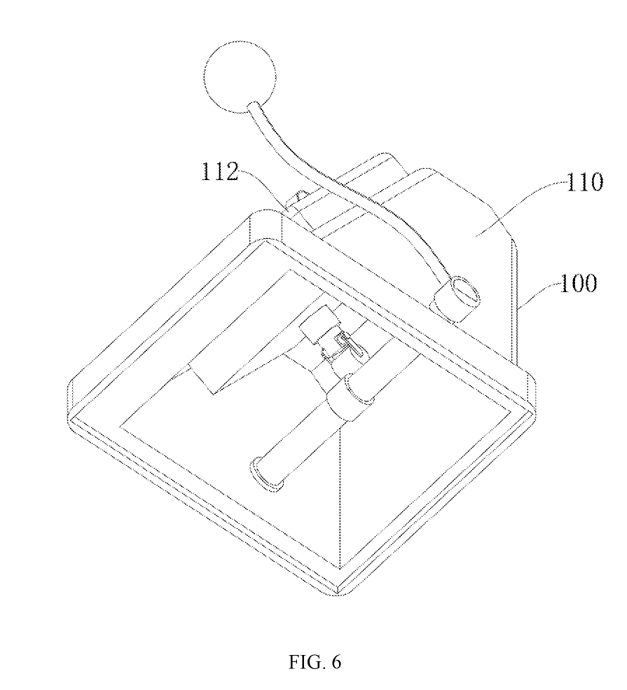

FIG. 7 is a structural perspective view of a return spring structure of the present disclosure.

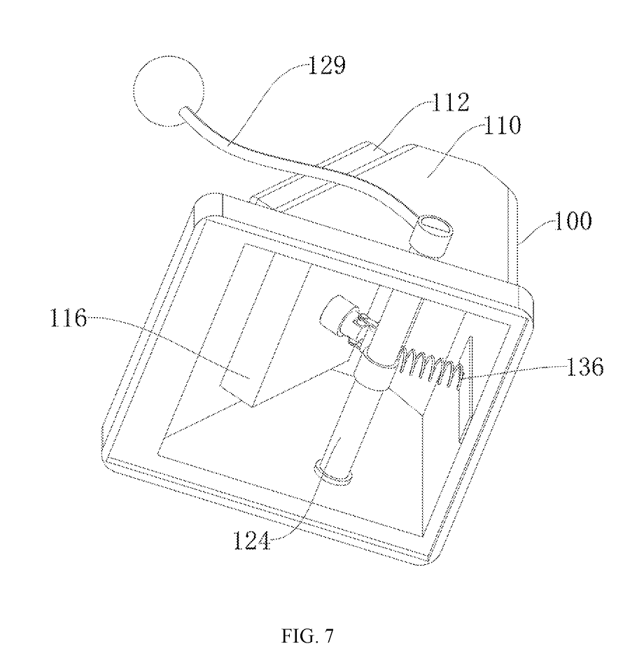

FIG. 8 is a structural exploded perspective view of a punching assembly of the present disclosure.

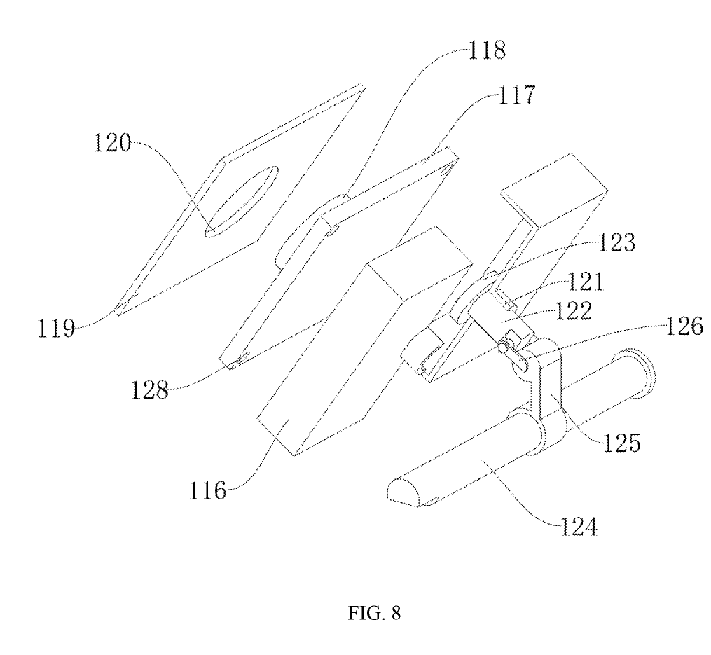

FIG. 9 is a structural perspective view of another view of FIG. 8 of the present disclosure.

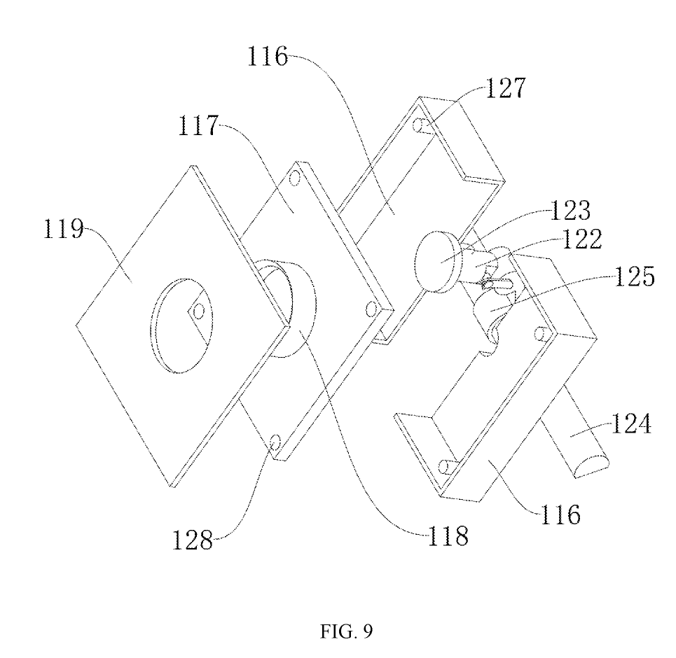

FIG. 10 is a partially enlarged structural perspective view of a connector of the present disclosure.

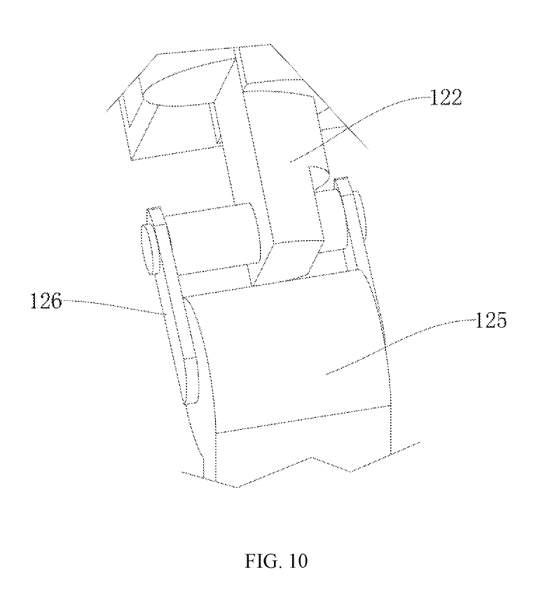

FIG. 11 is a structural exploded perspective view of a quick assembly mechanism in Embodiment 3 of the present disclosure.

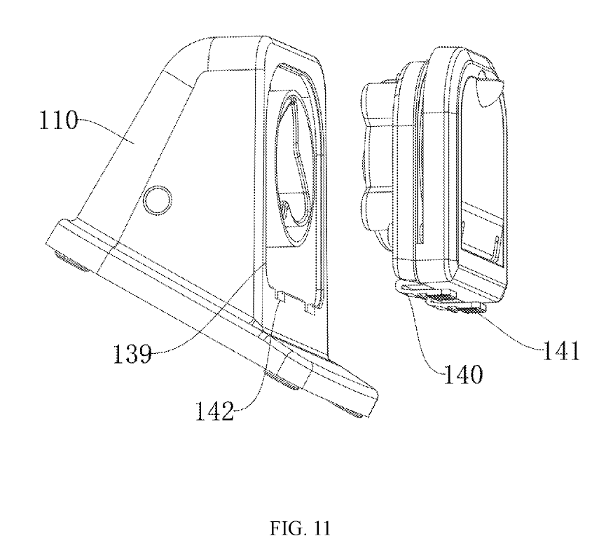

Reference numerals in the figures: 100-craft punch body; 110-main housing; 111-through slot; 112-protective cover; 113-single-sided opening; 114-discharge outlet; 115-visual cover plate; 116-blade installation cover; 117-blade base; 118-blade edge; 119-limiting base; 120-blade hole; 121-cylindrical sleeve; 122-ejector column; 123-rubber seat; 124-rotating rod; 125-pushing member; 126-connector; 127-guide column; 128-guide groove; 129-S-shaped connecting rod; 130-connecting sleeve; 131-insertion portion; 132-connecting end; 133-sphere; 134-bottom sealing plate; 135-anti-slip protruding strip; 136-return spring; 137-trigger portion; 138-magnet; 139-connecting opening portion; 140-elastic engaging portion; 141-press-fit fastener; and 142-engaging groove.

### DETAILED DESCRIPTIONS OF THE EMBODIMENTS

The technical solutions in the present disclosure will be clearly and completely described below with reference to the accompanying drawings in the present disclosure.

### Embodiment 1

A replaceable visual craft punch is provided in the present disclosure, including a craft punch body 100 as a core component including a main housing 110, a punching assembly, and a visual component.

A through slot 111 is elaborately formed on a front face of the main housing 110 as an external supporting structure of the entire device, and the through slot is mainly configured to provide a passage for entry and exit of a cutting tool component, so as to ensure a smooth punching operation.

The visual component focuses on enhancing the visibility of operation. A protective cover 112 is stably mounted on the front face of the main housing 110, a single-sided opening 113 is formed on a side of the protective cover 112 adjacent to the main housing 110, and this design breaks the strict limitation of a traditional craft punch on a material width. A front face of the protective cover 112 is further provided with a discharge outlet 114, and a cut-off material is quickly and conveniently taken out through the discharge outlet 114, which greatly improves the production efficiency. A visual cover plate 115 is installed in the discharge outlet 114 through a rotating column, and the visual cover plate 115 is made of a transparent material, such that when operating, a user observes the punching process in real time and clearly through the transparent visual cover plate 115, and accurately controls a position and final presentation effect of pattern, thereby achieving more free and creative crafting.

The punching assembly is crucial for achieving the punching function and includes the cutting tool component and a driving mechanism, where the driving mechanism accurately drives the cutting tool component to operate, so as to achieve a stable punching operation.

### Embodiment 2

Embodiment 2 is optimized and expanded on the basis of Embodiment 1.

The cutting tool component is more precise and complex in structure, including a blade installation cover 116, a blade base 117, and a limiting base 119. The blade installation cover 116 is detachably installed in the main housing 110, and an end opening thereof accurately corresponds to the through slot 111 on the main housing 110 to ensure the smooth entry and exit of blade. The blade base 117 is stably disposed in the blade installation cover 116 and quickly ejected by the driving mechanism due to a strong driving action, and closely cooperates with the limiting base 119 mounted on an inner side of the protective cover 112, where the two bases cooperate tacitly to complete the punching action. The blade base 117 is provided with a sharp blade edge 118, and the limiting base 119 is correspondingly provided with a blade hole 120, where the blade edge 118 and the blade hole 120 are accurately matched in size and closely fitted, and this exquisite design effectively ensures the accuracy and quality of punching, making punched patterns clear and regular.

The driving mechanism integrates a variety of exquisite designs. The driving mechanism includes a cylindrical sleeve 121, an ejector column 122, a rotating rod 124, a pushing member 125, a connector 126, and a handle. The cylindrical sleeve 121 is integrally formed with the blade installation cover 116, which is like a solid track that plays a stable guiding role for the ejector column 122, and the ejector column 122 slides smoothly in the cylindrical sleeve 121, to accurately push the blade base 117 to achieve an efficient punching operation. The rotating rod 124 is connected in the main housing 110 through a bearing, and an end thereof extends out of the main housing 110 and is connected to the ergonomically designed handle, such that the user holds the handle for operation in an extremely comfortable manner. The pushing member 125 is stably fixed on an outer surface of the rotating rod 124, the connector 126 is fixed on the pushing member 125, the connector 126 is connected to the ejector column 122 in a hinged manner, and when the user presses down the handle, a force drives the ejector column 122 to accurately push through the pushing member 125 and the connector 126 in cooperation with the cylindrical sleeve 121, such that a convenient and efficient operation is achieved in one go.

In order to further improve the accuracy, four guide columns 127 are further installed in the blade installation cover 116, and the blade base 117 is provided with four guide grooves 128 corresponding to the guide columns 127, which provides precise guidance for the blade base 117 and the blade edge 118 during high-speed operation, effectively prevents deviation, and comprehensively ensures the punching accuracy. A rubber seat 123 is fixedly mounted at an end of the ejector column 122 close to the blade base 117, and the rubber seat 123 has both anti-slip and buffering functions, which not only prevents slipping when the ejector column 122 comes into contact with the blade base 117, but also further buffers an impact force during pushing, and prolongs the service life of the replaceable visual craft punch.

The handle is also designed to be unique and ingenious, including an S-shaped connecting rod 129 and a sphere 133, where the S-shaped connecting rod 129 is connected to a distal end of the rotating rod 124, the sphere 133 is fixed at an end of the S-shaped connecting rod 129 away from the rotating rod 124, and an outer surface of the sphere 133 is wrapped with a rubber sleeve, which conforms to the hand grasping habit, facilitates the user’s holding for a long time, and enhances the use comfort. A return spring 136 is mounted on a back side of the pushing member 125, an end of the return spring 136 is fixedly connected to an inner wall of the main housing 110, and after one punching operation, the return spring 136 automatically drives the rotating rod 124 to reset by virtue of its own elastic force, without need of tedious manual adjustment, which enables to quickly start the next punching operation and greatly improves the work efficiency.

A bottom end of the main housing 110 has an opening, a bottom sealing plate 134 is detachably installed in the opening, and this design greatly facilitates the maintenance, repair, and replacement of internal components of the main housing 110, and makes the later maintenance easy and convenient. Anti-slip protruding strips 135 are uniformly fixed at a bottom end of the bottom sealing plate 134, which significantly enhances the stability of the craft punch body 100 when placed, and prevents accidental sliding even in the case of external force collision during operation, thereby ensuring the operational safety.

A trigger portion 137 is disposed on a front face of the visual cover plate 115, and the user conveniently opens the visual cover plate 115 by gently pressing the trigger portion 137 to clean the debris in the discharge outlet 114 or inspect the internal condition at any time, so as to keep the replaceable visual craft punch clean. A magnet 138 is mounted on an inner side of the visual cover plate 115, and magnetic adsorption stably enhances the sealing stability of the visual cover plate 115 when closed, effectively prevents leakage of debris, and maintains a clean operation environment. The handle further includes a connecting sleeve 130, an insertion portion 131, and a connecting end 132, where the connecting sleeve 130 is connected to the S-shaped connecting rod 129, the connecting end 132 is disposed at the distal end of the rotating rod 124, the insertion portion 131 is disposed on the connecting sleeve 130, and the insertion portion 131 is adapted to the connecting end 132, which achieves quick disassembly and assembly of the handle, meets carrying needs in different scenarios, improves the portability of the replaceable visual craft punch, and greatly facilitates both home crafting and outdoor use.

### Embodiment 3

Embodiment 3 is optimized and expanded on the basis of Embodiment 1.

The craft punch body 100 is further provided with a quick assembly mechanism, and the mechanism is intended to achieve the quick replacement of different punching assemblies so as to meet diversified punching needs. The quick assembly mechanism is mainly composed of a connecting opening portion 139 disposed on the main housing 110. The connecting opening portion 139 is exquisitely designed, and two engaging grooves 142 are symmetrically formed at an edge thereof. The two engaging grooves 142 are in a regular rectangle shape, with a moderate depth and smooth inner walls, and closely cooperate with elastic engaging portions 140.

Correspondingly, two elastic engaging portions 140 perfectly adapted to the engaging grooves 142 are disposed at a bottom end of the punching assembly. The elastic engaging portions 140 are made of a high-elasticity and wear-resistant plastic material, and have good flexibility and resilience. The elastic engaging portions match the engaging grooves 142 in shape, and during installation, the elastic engaging portions 140 are smoothly snap-fitted into the engaging grooves 142 by virtue of their own elasticity only by accurately aligning the elastic engaging portions 140 with the engaging grooves 142 and gently pressing, thereby achieving quick installation of the punching assembly, and greatly improving the work efficiency due to the simple and quick installation process.

It is worth mentioning that a press-fit fastener 141 is further disposed on the elastic engaging portion 140. The press-fit fastener 141 is flat, and a surface thereof is designed with anti-slip textures to facilitate force application by the user’s finger. When the punching assembly needs to be disassembled, the user only needs to pull the press-fit fastener 141 upward, and the press-fit fastener 141 drives the elastic engaging portion 140 to deform and detach from the engaging groove 142, such that locking between the punching assembly and the main housing 110 is quickly released, thereby achieving the quick disassembly of the punching assembly.

Finally, it should be noted that: first, in the description of the present disclosure, it should be noted that unless expressly specified and defined otherwise, the terms “mounting”, “connection”, “connected”, etc. are to be construed broadly and, for example, may also refer to a mechanical connection or an electrical connection, communication inside two elements or a direct connection; the terms "upper", "lower", "left", "right" and the like are only used to indicate the relative positional relationship, and when an absolute position of an object being described changes, the relative positional relationship may change;

second, in the accompanying drawings of the disclosed embodiments of the present disclosure, only the structures related to the disclosed embodiments are involved, usual designs can be referred to for other structures, and under the condition of no conflict, the same embodiment of the present disclosure and different embodiments can be combined mutually; and

finally, the above are merely preferred embodiments of the present disclosure, and are not intended to limit the present disclosure. Any modifications, equivalent replacements and improvements made within the spirit and principle of the present disclosure should fall within the protection scope of the present disclosure.

What is claimed is:

1. A replaceable visual craft punch, comprising a craft punch body, wherein the craft punch body comprises a main housing, a punching assembly, and a visual component, wherein a through slot is formed on a front face of the main housing, and is configured to provide a passage for entry and exit of a cutting tool component; the visual component comprises a protective cover, the protective cover is mounted on the front face of the main housing, a single-sided opening is formed on a side of the protective cover adjacent to the main housing to facilitate flat placement of materials of different widths to be processed, and a front face of the protective cover is provided with a discharge outlet to facilitate taking out a cut-off material; a visual cover plate is installed in the discharge outlet through a rotating column, and the visual cover plate is made of a transparent material, such that a user observes a punching process in real time and clearly through the visual cover plate, and controls a position and effect of pattern; and the punching assembly comprises a cutting tool component and a driving mechanism, wherein the driving mechanism drives the cutting tool component to operate, so as to achieve a punching operation.

2. The replaceable visual craft punch according to claim 1, wherein the cutting tool component comprises a blade installation cover, a blade base, and a limiting base, wherein the blade installation cover is detachably installed in the main housing, and an end opening thereof corresponds to the through slot on the main housing, the blade base is disposed in the blade installation cover and ejected by the driving mechanism, and cooperates with the limiting base mounted on an inner side of the protective cover to complete a punching action, the blade base is provided with a blade edge, and the limiting base is provided with a blade hole, wherein the blade edge and the blade hole are closely fitted to ensure the accuracy and quality of punching.

3. The replaceable visual craft punch according to claim 2, wherein the driving mechanism comprises a cylindrical sleeve, an ejector column, a rotating rod, a pushing member, a connector, and a handle, wherein the cylindrical sleeve is integrally formed with the blade installation cover, which plays a stable guiding role for the ejector column, and the ejector column slides in the cylindrical sleeve, to push the blade base to achieve a punching operation; the rotating rod is connected in the main housing through a bearing, and an end thereof extends out of the main housing and is connected to the handle; the pushing member is fixed on an outer surface of the rotating rod, the connector is fixed on the pushing member, the connector is connected to the ejector column in a hinged manner, and when the user presses down the handle, the ejector column is driven to push through the pushing member and the connector in cooperation with the cylindrical sleeve, such that a convenient and efficient operation is achieved.

4. The replaceable visual craft punch according to claim 3, wherein four guide columns are installed in the blade installation cover, and the blade base is provided with four guide grooves corresponding to the guide columns, which provides precise guidance for the blade base and the blade edge during operation, prevents deviation, and further ensures the punching accuracy.

5. The replaceable visual craft punch according to claim 3, wherein a rubber seat is fixedly mounted at an end of the ejector column close to the blade base, and the rubber seat not only has an anti-slip function and prevents slipping when the ejector column comes into contact with the blade base, but also has a buffering function, reduces an impact force, and prolongs the service life of the replaceable visual craft punch.

6. The replaceable visual craft punch according to claim 3, wherein the handle comprises an S-shaped connecting rod and a sphere, wherein the S-shaped connecting rod is connected to a distal end of the rotating rod, the sphere is fixed at an end of the S-shaped connecting rod away from the rotating rod, and an outer surface of the sphere is wrapped with a rubber sleeve, which conforms to ergonomic design principles, facilitates the user’s holding, and enhances use comfort.

7. The replaceable visual craft punch according to claim 3, wherein a return spring is mounted on a back side of the pushing member, an end of the return spring is fixedly connected to an inner wall of the main housing, and after one punching operation, the return spring automatically drives the rotating rod to reset, without need of manual adjustment, which enables to quickly start the next punching operation and improves the work efficiency.

8. The replaceable visual craft punch according to claim 1, wherein a bottom end of the main housing has an opening, and a bottom sealing plate is detachably installed in the opening, which greatly facilitates maintenance, repair, and replacement of internal components of the main housing; and anti-slip protruding strips are uniformly fixed at a bottom end of the bottom sealing plate, which enhances stability of the craft punch body when placed, and prevents accidental sliding during operation.

9. The replaceable visual craft punch according to claim 1, wherein a trigger portion is disposed on a front face of the visual cover plate, and the user conveniently opens the visual cover plate by pressing the trigger portion to clean the discharge outlet or inspect an internal condition; a magnet is mounted on an inner side of the visual cover plate, and magnetic adsorption enhances sealing stability of the visual cover plate when closed, and prevents leakage of debris; the craft punch body further comprises a quick assembly mechanism configured to quickly replace different punching assemblies, the quick assembly mechanism comprises a connecting opening portion disposed on the main housing, and two engaging grooves are formed at an edge of the connecting opening portion; two elastic engaging portions adapted to the engaging grooves are disposed at a bottom end of the punching assembly, and quick installation of the punching assembly is achieved by aligning the elastic engaging portions with the engaging grooves; and a press-fit fastener is further disposed on the elastic engaging portion, and locking between the punching assembly and the main housing is quickly released by pressing the press-fit fastener upward.

10. The replaceable visual craft punch according to claim 6, wherein the handle further comprises a connecting sleeve, an insertion portion, and a connecting end, wherein the connecting sleeve is connected to the S-shaped connecting rod, the connecting end is disposed at the distal end of the rotating rod, the insertion portion is disposed on the connecting sleeve, and the insertion portion is adapted to the connecting end, which achieves quick disassembly and assembly of the handle, meets different carrying needs, and improves portability of the replaceable visual craft punch.
